(19) United States
(12) Patent Application Publication
(10) Pub. No.: US 2024/0249336 A1
(43) Pub. Date: Jul. 25, 2024

(54) COMPUTER BASED ASSISTANT FOR PROMOTING UPGRADES TO AUTOMATION PRODUCTS AND SERVICES

(71) Applicant: Siemens Aktiengesellschaft, Munich (DE)

(72) Inventors: Arquimedes Martinez Canedo, Plainsboro, NJ (US); Lingyun Wang, Princeton, NJ (US)

(73) Assignee: Siemens Aktiengesellschaft, Munich (DE)

(21) Appl. No.: 18/293,793

(22) PCT Filed: Aug. 13, 2021
(86) PCT No.: PCT/US2021/045907

§ 371 Date: Jan. 31, 2024

(51) Int. Cl. G06Q 30/0601

(52) U.S. Cl. CPC G06Q 30/0631; G06Q 30/0603

(57) ABSTRACT

A system and method for promoting candidate plans for upgrade in vendor provided devices or services. A context engine generates an automation context term for a target application using inference algorithms based on a retrieved ontology of the industrial automation system. A mapping engine queries a digital catalog for candidate upgrade devices or services related to the context term and maps key performance indicators related to the context term for each candidate device or service. A cost-performance engine estimates performance improvement for each of the candidate upgrade devices or services using algorithms that generate one or more simulation models for calculating the performance improvements. A ranked list of candidate plans for upgrade of devices or services is delivered with cost and performance information to one or more graphical user interfaces in the automation system for display to a one or more users.

### TECHNICAL FIELD

This application relates to data processing. More particularly, this application relates to a computer-based assistant for navigation and promotion of automation products, services, and solutions.

### BACKGROUND

Up until now, automation users rely on catalogs of products and services from automation vendors during design, operation, and maintenance activities. FIG. 1A shows an example of such a product line catalog screen 100 for browsing and searching for a component 101. FIG. 1B shows an example of a catalog screen 150 from which a service 151 may be selected. This is a passive approach for finding products and services. The catalog approach is slow, inefficient and generates additional marketing expenses for automation vendors. For example, navigating hierarchical pull-down menus with product line information in an interactive display requires expert knowledge of an automation vendor's product line as well as the automation domain in general. This is due to the lack of contextual information provided in such hierarchical displays, typically being limited to vendor unique product identification tags for automation systems, components, and subcomponents of a hierarchical tree, such as the menu tag for component 101 which reads “SM 522 digital output modules”.

### SUMMARY

System and method provide a computer-based assistant for navigation and promotion of automation products, services, and solutions. Inference algorithms are used to generate automation application context. A current state of the installed automation system devices is extracted from a system database and the currently installed devices are mapped to a supplier catalog of related devices to generate a set of alternative devices. A cost-performance engine performs a comparative analysis using discipline-based models or simulation models with cost-performance key performance indicators (KPIs) to project performance improvement for one or more device replacements with associated installation costs. Multiple options for device replacements are presented as a list or table sortable by performance, cost, number of devices, and the like. Hence, a user is provided with ranked list of upgrade candidates enabling an informed decision. Cost-performance improvements are determined through mathematical modeling algorithms for one or more device replacements or upgrades. The upgrade candidate list and cost-performance results may be delivered directly to various engineering and operations personnel responsible for the automation system via respective delivery formats and mechanisms including CAD for designers, PLC programming platform or engineering tools for engineers, and human machine interface (HMI) for shop floor operators. The computer-based assistant may also process vendor orders for selected device replacements, setup and track installation scheduling with sales and distribution channels, and monitor delivery information for the replacement devices.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1A shows an example of a conventional electronic product catalog for searching for automation system components.

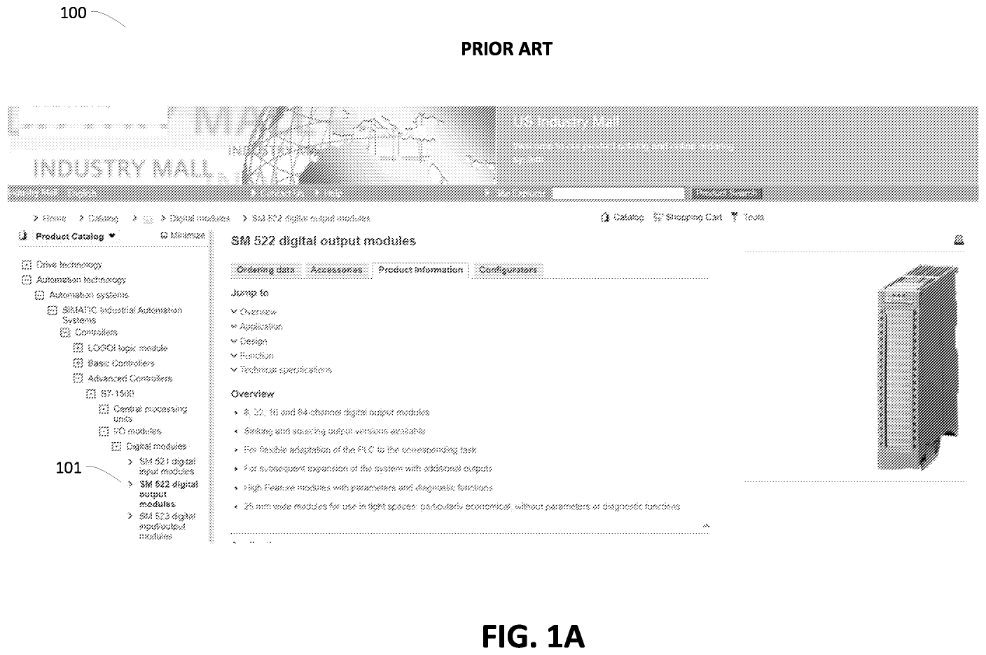

FIG. 1B shows an example of a conventional electronic product catalog for searching for automation system services.

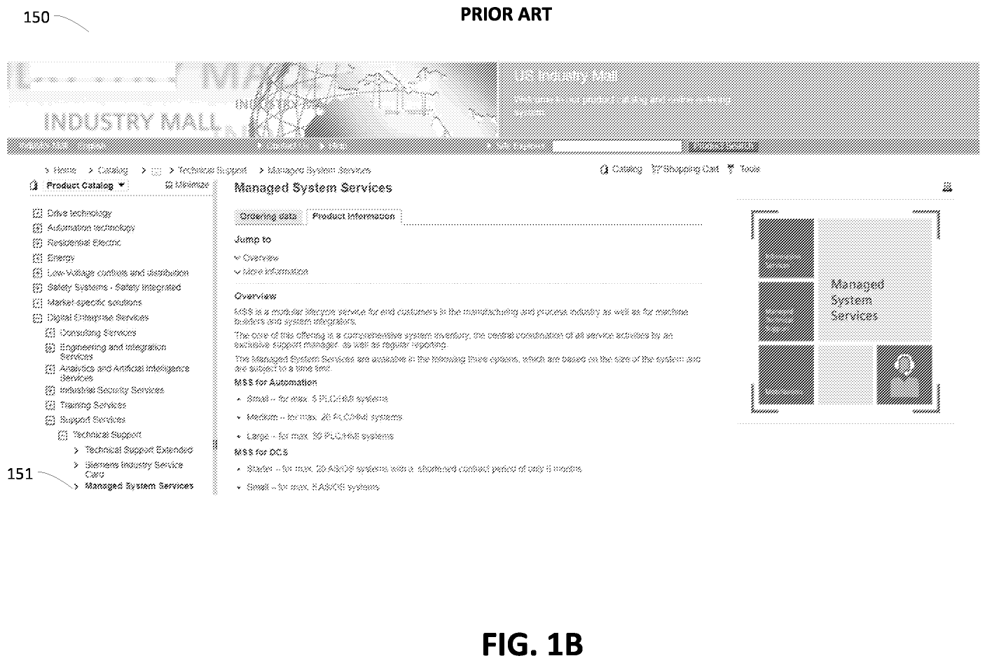

FIG. 2 shows an example of a system process flowchart for a computer-based assistant that recommends device procurement and performance upgrade in accordance with embodiments of this disclosure.

FIG. 3 illustrates an example of a computing environment within which embodiments of the present disclosure may be implemented.

### DETAILED DESCRIPTION

System and method are disclosed for a computer-based assistant for procurement or upgrading of devices in an automation system. Unlike state-of-the-art approaches that require customers to browse catalogs from top to bottom, or involve customer assistance from a vendor sales representative, the disclosed embodiments use artificial intelligence to automatically match installed devices of an industrial automation plant to potential replacements of equal or superior level of performance from a complete catalog of a vendor's products and services. As one technical advantage, the user need not have a high level of knowledge and expertise as reliance is shifted to the highly capable computer-based assistant to recommend suitable replacements and upgrades of machines, devices and parts throughout the automation system. In addition, the computer-based assistant can also provide ranked choices according to a cost-performance scale. Another advantage can be appreciated on the vendor side by alleviating the burden on the sales force to determine which products and services to promote to the customer, as the computer-based assistant has superior ability to promote vendor products that strongly match a customer's automation system setup.

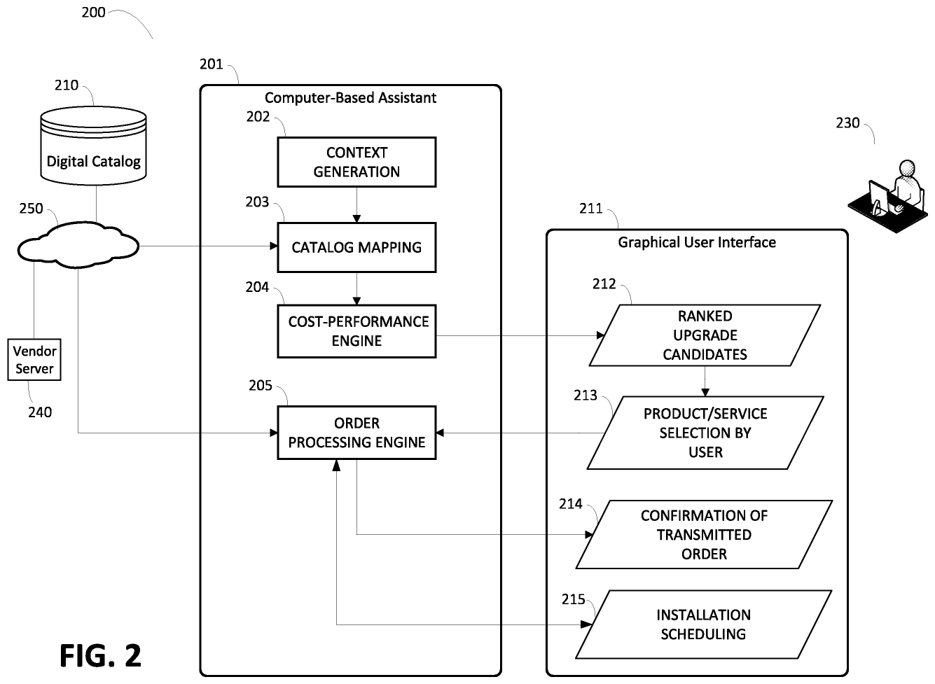

FIG. 2 shows an example of a system process flowchart for a computer-based assistant that recommends device procurement and performance upgrade in accordance with embodiments of this disclosure. Computer-based assistant 201 comprises context generation engine 202, catalog mapping engine 203, cost-performance engine 204, and order processing engine 205. Using data from a digital catalog 210, the modules of computer-based assistant 201 presents upgrade options to a user 230 via a graphical user interface 211.

Context generation engine 202 is configured to generate an automation context for a target application that may benefit from an upgrade or replacement of a vendor provided product or service. In an embodiment, context generation engine 202 can probe an ontology of the automation system looking at the types of devices connected in the automation network, control variable names and control function blocks, and from this information, infer the target application. For example, a scan of the ontology may reveal that an HMI system is connected to a motor in the automation system, and an HMI Screen is displaying a “rpm” value. By executing an inference algorithm (e.g., a natural language processing (NLP) algorithm) on this input information, context generation engine 202 generates a context term of “Motion Control” for the target application in this instance. For example, the inference algorithm may extract context scanned from running systems and infer/deduce the type of applications from the context (e.g., Motion Control, Production Machine, Logic Control, etc.). The learning/training may be derived from existing systems worldwide. In an embodiment, the context generation engine 202 operates on a schedule as follows. The trigger for operation may correspond with the regular maintenance period for the automation system (e.g., yearly maintenance program). This way recommended replacement parts can be determined and ordered for the required maintenance. Additionally, or alternatively, the context generation engine 202 may be scheduled to run periodically to scan the automation system and provide the recommendations. For example, a monthly operation that coincides with system idle time may be scheduled for the scan to minimize interference with normal operations.

Mapping engine 203 is configured to map the context term against a digital catalog 210 of the vendor to establish whether there are any candidate products or services related to the context term that could serve as an upgrade to improve performance of the automation system. For the “motion control” example, mapping engine 203 queries the digital catalog 210 and determines any candidate upgrade devices or services in the digital catalog 210 related to motion control of a motor. In an embodiment, text string matching is executed to identify candidate upgrade devices and services categorized under the target application (e.g., motion control). According to an embodiment, mapping engine 203 also maps key performance indicators (KPIs) related to the context term. For example, a KPI query of the digital catalog 210 related to context term “Motion Control” may yield a linked metric for “rpm ramps”, and/or other metrics related to “Motion Control”. KPI metrics may be stored in digital catalog 210, where each target application is linked to a set of associated KPI metrics (e.g., Motion control [linked to] Motor rpm, position accuracy, energy efficiency KPIs, etc.).

Cost-performance engine 204 is configured to generate different plans based on estimates of improved performance related to the target application, using the candidate upgrade devices and services with associated KPIs as inputs. Performance improvement plans are based on one or more discipline-based physics and system modeling combined with cost-performance analysis. In an embodiment, cost-performance engine 204 includes algorithms that generate one or more simulation models, such as mathematical or physics models of an underlying discipline (e.g., electrical, mechanical), which compute estimated performance improvement using a candidate upgrade device or service. For example, a set of electrical candidate upgrade devices such as a driver motor used to propel a robotic arm, may be modeled for simulating load bearing performance and may be analyzed to assess predicted performance according to estimated measurements of energy consumption, speed and torque under full load capacity. Similarly, mechanical properties, automation control properties, and other aspects of interest for upgrade candidates may be modeled and analyzed. For each proposed upgrade plan, the result provides the projections of performance improvement if one or more devices are replaced or services are performed, and an associated cost for the new devices, service, and/or installation. Cost-performance engine 204 can extract cost information from the digital catalog 210. The different upgrade candidates are ranked according to performance, cost, cost-performance benefit, number of replacement devices, or a combination thereof. A ranked list of upgrade candidate devices or services 212 is sent to a user interface for further interaction.

Graphical user interface (GUI) 211 is communicatively coupled to the computer-based assistant 201 for display of output information and for user interaction in making selections for upgrade candidates. In an embodiment, computer-based assistant 201 delivers the upgrade proposal information to existing workstation displays in and around the automation system being services. As such, deployment of the assistant 201 uses existing automation equipment or software when presenting the upgrade proposals and promotions. For example, GUI 211 may be implemented in various forms on different platforms throughout different locations in the automation system environment, enabling different operators to access the candidate upgrade information. In an aspect, ranked lists of candidate upgrade devices or services 212 and corresponding cost performance results may be delivered directly to various engineering and operations personnel responsible for the automation system via respective delivery formats and mechanisms including a CAD tool displayed on a PC screen for designers, PLC programming platform or engineering tools for engineers displayed on a PC screen, and human machine interface (HMI) devices for shop floor operators displayed on fixed machine-level display panels or hand held tablet devices. An advantage of presenting cost-performance results for each candidate provides the user 230 with confidence when placing an order, eliminating guess work.

Given the ranked list of candidate upgrade devices or services 212, user 230 interacts with GUI 211 to make one or more selections for placement of an order for an upgrade device or service 213. In an aspect, the selection may be entered in various forms, depending on capability of the GUI 211, such as touch screen tapping, keyboard entry, mouse selection on a screen menu, or the like.

Order processing engine 205 is configured to accept a user order 213 and to submit the order to the vendor ordering system using a communication network 250 (e.g., the internet) connected to a vendor server 240. Confirmation of the order placement is received by order processing engine 205 and forwarded to GUI 211 for viewing by user 230. Delivery options, such as shipping information and scheduling for installation can be presented and selected using order processing engine 205 by exchanging two-way communication between vendor server 240 and user 230. For example, vendor delivery options for the order may be presented to user 230 on GUI 211 where the user can make the selection for delivery. Order processing engine 205 may then submit the selected delivery option to the vendor ordering system at vendor server 240. In an embodiment, order processing engine 205 autonomously schedules an installation appointment with sales and distribution channels of the vendor via communications with vender server 240 over a communication network 250 connection. Order processing engine 205 also provides delivery options, tracks delivery status, and autonomously schedules installation 215, the information of which is presented to user 230 on a display screen of GUI 211.

Advantages of the described embodiments include the following. Vendors of replacement parts can directly promote new automation devices to responsible personnel of existing customers through intelligent aspects introduced to the automation system, avoiding typical indirect sales channels. The technical advantage of this is that system operators can appreciate receiving targeted performance improvement opportunities that are on point as a useful tool for preventative maintenance. A streamlined chain for part replacement is the result, minimizing delays and outages due to maintenance.

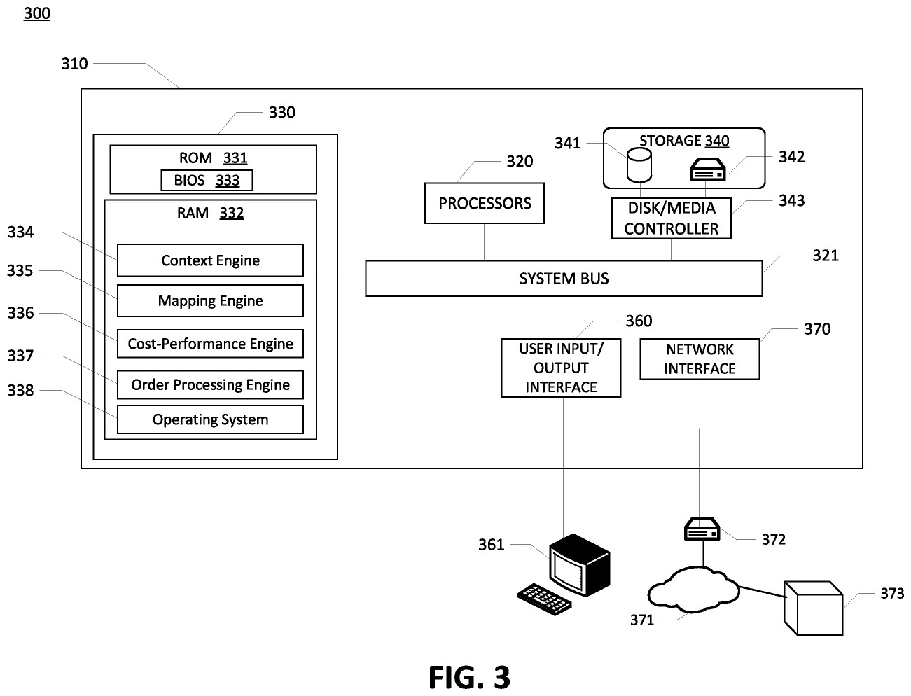

FIG. 3 illustrates an example of a computing environment within which embodiments of the present disclosure may be implemented. A computing environment 300 includes a computer system 310 that may include a communication mechanism such as a system bus 321 or other communication mechanism for communicating information within the computer system 310. The computer system 310 further includes one or more processors 320 coupled with the system bus 321 for processing the information. In an embodiment, computing environment 300 corresponds to a system for computer-based assistance for product and service upgrades and promotions for automation systems, in which the computer system 310 relates to a computer described below in greater detail.

The processors 320 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 320 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 321 may include at least one of a system bus, a memory bus, an address bus, or a message bus, and may permit exchange of information (e.g., data (including computer-executable code), signaling, etc.) between various components of the computer system 310. The system bus 321 may include, without limitation, a memory bus or a memory controller, a peripheral bus, an accelerated graphics port, and so forth. The system bus 321 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 3, the computer system 310 may also include a system memory 330 coupled to the system bus 321 for storing information and instructions to be executed by processors 320. The system memory 330 may include computer readable storage media in the form of volatile and/or nonvolatile memory, such as read only memory (ROM) 331 and/or random access memory (RAM) 332. The RAM 332 may include other dynamic storage device(s) (e.g., dynamic RAM, static RAM, and synchronous DRAM). The ROM 331 may include other static storage device(s) (e.g., programmable ROM, erasable PROM, and electrically erasable PROM). In addition, the system memory 330 may be used for storing temporary variables or other intermediate information during the execution of instructions by the processors 320. A basic input/output system 333 (BIOS) containing the basic routines that help to transfer information between elements within computer system 310, such as during start-up, may be stored in the ROM 331. RAM 332 may contain data and/or program modules that are immediately accessible to and/or presently being operated on by the processors 320. System memory 330 additionally includes modules for executing the described embodiments, such as context engine 334, mapping engine 335, cost-performance engine 336 and order processing engine 337. In an embodiment, context engine 334, mapping engine 335, cost-performance engine 336 and order processing engine 337 are configured to execute instructions to perform functionality as described above for context generation 202, catalog mapping 203, cost-performance engine 204 and order processing engine 205 as described above with reference to FIG. 2.

The operating system 338 may be loaded into the memory 330 and may provide an interface between other application software executing on the computer system 310 and hardware resources of the computer system 310. More specifically, the operating system 338 may include a set of computer-executable instructions for managing hardware resources of the computer system 310 and for providing common services to other application programs (e.g., managing memory allocation among various application programs). In certain example embodiments, the operating system 338 may control execution of one or more of the program modules depicted as being stored in the data storage 340. The operating system 338 may include any operating system now known or which may be developed in the future including, but not limited to, any server operating system, any mainframe operating system, or any other proprietary or non-proprietary operating system.

The computer system 310 may also include a disk/media controller 343 coupled to the system bus 321 to control one or more storage devices for storing information and instructions, such as a magnetic hard disk 341 and/or a removable media drive 342 (e.g., floppy disk drive, compact disc drive, tape drive, flash drive, and/or solid state drive). Storage devices 340 may be added to the computer system 310 using an appropriate device interface (e.g., a small computer system interface (SCSI), integrated device electronics (IDE), Universal Serial Bus (USB), or FireWire). Storage devices 341, 342 may be external to the computer system 310.

The computer system 310 may include a user input/output interface 360 for communication with a GUI 361, which may comprise one or more input devices, such as a keyboard, touchscreen, tablet and/or a pointing device, for interacting with a computer user and providing information to the processors 320. For example, input device may be implemented as described with reference to GUI 211 of FIG. 2, by which a user may enter a product or service selection 213 from among the ranked upgrade candidates 212. In an aspect, the GUI 361 further relates to the GUI device 211 of FIG. 2 for displaying ranked upgrade candidates 212, a confirmation of transmitted order 214, and/or installation scheduling 215.

The computer system 310 may perform a portion or all of the processing steps of embodiments of the invention in response to the processors 320 executing one or more sequences of one or more instructions contained in a memory, such as the system memory 330. Such instructions may be read into the system memory 330 from another computer readable medium of storage 340, such as the magnetic hard disk 341 or the removable media drive 342. The magnetic hard disk 341 and/or removable media drive 342 may contain one or more data stores and data files used by embodiments of the present disclosure. The data store 340 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 320 may also be employed in a multi-processing arrangement to execute the one or more sequences of instructions contained in system memory 330. In alternative embodiments, hard-wired circuitry may be used in place of or in combination with software instructions. Thus, embodiments are not limited to any specific combination of hardware circuitry and software.

As stated above, the computer system 310 may include at least one computer readable medium or memory for holding instructions programmed according to embodiments of the invention and for containing data structures, tables, records, or other data described herein. The term “computer readable medium” as used herein refers to any medium that participates in providing instructions to the processors 320 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 341 or removable media drive 342. Non-limiting examples of volatile media include dynamic memory, such as system memory 330. Non-limiting examples of transmission media include coaxial cables, copper wire, and fiber optics, including the wires that make up the system bus 321. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 300 may further include the computer system 310 operating in a networked environment using logical connections to one or more remote computers, such as remote computing device 373. The network interface 370 may enable communication, for example, with other remote devices 373 or systems and/or the storage devices 341, 342 via the network 371. Remote computing device 373 may be a personal computer (laptop or desktop), a mobile device, a server, a router, a network PC, a peer device or other common network node, and typically includes many or all of the elements described above relative to computer system 310. When used in a networking environment, computer system 310 may include modem 372 for establishing communications over a network 371, such as the Internet. Modem 372 may be connected to system bus 321 via user network interface 370, or via another appropriate mechanism.

Network 371 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 310 and other computers (e.g., remote computing device 373). The network 371 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 371.

It should be appreciated that the program modules, applications, computer-executable instructions, code, or the like depicted in FIG. 3 as being stored in the system memory 330 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 310, the remote device 373, and/or hosted on other computing device(s) accessible via one or more of the network(s) 371, may be provided to support functionality provided by the program modules, applications, or computer-executable code depicted in FIG. 3 and/or additional or alternate functionality. Further, functionality may be modularized differently such that processing described as being supported collectively by the collection of program modules depicted in FIG. 3 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 3 may be implemented, at least partially, in hardware and/or firmware across any number of devices.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-based system for promoting candidate plans of upgrade in vendor provided devices and services of an industrial automation system, comprising:
a processor, and
a processor, and
a memory having instructions stored in modules executable by the processor, the modules comprising:
a context engine configured to generate an automation context term for a target application using inference algorithms based on a retrieved ontology of the industrial automation system, wherein the ontology includes information regarding connected devices, control variable names, and control function blocks related to devices of the industrial automation system;
a mapping engine configured to query a digital catalog for candidate upgrade devices or services related to the context term and to map key performance indicators related to the context term for each candidate device or service; and
a cost-performance engine configured to:
estimate performance improvement for each of the candidate upgrade devices or services, the cost-performance engine comprising algorithms that generate one or more simulation models for computing estimated performance improvements and an extraction component to extract cost information from the digital catalog;
rank the candidate upgrade devices or services according to cost, performance, or cost-performance benefit; and
deliver a ranked list of candidate upgrade plans for upgrade of devices or services with cost and performance information to one or more graphical user interfaces in the automation system for display to a one or more users.

2. The system of claim 1, wherein the cost-performance engine is further configured to rank the list of candidate upgrade plans according to cost, cost-performance benefit, number of replacement devices, or a combination thereof.

3. The system of claim 1, wherein the one or more simulation models include mathematical or physics models of an underlying discipline. cost-performance engine includes algorithms that generate mathematical or physics models of an underlying discipline or simulation models, for analysis of predicted performance improvement using a candidate upgrade device or service.

4. The system of claim 1, further comprising:
an order processing engine configured to:
receive, from the one or more graphical user interfaces, a user selection of one or more devices or services for placement of an order;
submit the order to a vendor ordering system using a connected communication network; and
forward confirmation of the order placement to the one or more graphical user interfaces.

5. The system of claim 4, wherein the order processing engine is further configured to:
present vendor delivery options using the one or more graphical user interfaces, and
submit a user selected delivery option to the vendor ordering system.

6. The system of claim 4, wherein the order processing engine is further configured to autonomously schedule an installation appointment with sales and distribution channels of the vendor via communications with a vendor server over a communication network connection.

7. The system of claim 4, wherein the order processing engine is further configured to provide delivery options and autonomous installation scheduling to the user on a display screen of the one or more graphical user interfaces.

8. A computer-based method for promoting candidate plans of upgrade in vendor provided devices or services of an industrial automation system, comprising:
generating an automation context term for a target application using inference algorithms based on a retrieved ontology of the industrial automation system, wherein the ontology includes information regarding connected devices, control variable names, and control function blocks related to devices of the industrial automation system;
querying a digital catalog for candidate upgrade devices or services related to the context term;
mapping key performance indicators related to the context term for each candidate device or service;
estimating performance improvement for each of the candidate upgrade devices and services, the cost-performance engine comprising algorithms that generate one or more simulation models for computing estimated performance improvements and an extraction component to extract cost information from the digital catalog;
ranking the candidate upgrade devices or services according to cost, performance, or cost-performance benefit; and
delivering a ranked list of candidate plans for upgrade of devices or services with cost and performance information to one or more graphical user interfaces in the automation system for display to a one or more users.

9. The method of claim 8, wherein the ranking of candidate upgrade plans is according to cost, cost-performance benefit, number of replacement devices, or a combination thereof.

10. The method of claim 8, wherein the one or more simulation models include mathematical or physics models of an underlying discipline. cost-performance engine includes algorithms that generate mathematical or physics models of an underlying discipline or simulation models, for analysis of predicted performance improvement using a candidate upgrade device or service.

11. The method of claim 8, further comprising:
receiving, from the one or more graphical user interfaces, a user selection of one or more devices or services for placement of an order;
submitting the order to a vendor ordering system using a connected communication network; and
forwarding confirmation of the order placement to the one or more graphical user interfaces.

12. The method of claim 11, further comprising:
presenting vendor delivery options using the one or more graphical user interfaces, and
submitting a user selected delivery option to the vendor ordering system.

13. The method of claim 11, further comprising:
autonomously scheduling, by an order processing engine of the computer, an installation appointment with sales and distribution channels of the vendor via communications with a vendor server over a communication network connection.

14. The method of claim 11, further comprising:
providing delivery options and autonomous installation scheduling to the user on a display screen of the one or more graphical user interfaces.
